(19) United States
(12) Patent Application Publication
(10) Pub. No.: US 2026/0073333 A1
(43) Pub. Date: Mar. 12, 2026

(54) SYSTEM AND METHOD FACILITATING ORGANIZATION RESILIENCE

(71) Applicant: INFINITE BLUE IP, LLC, Audubon, PA (US)

(72) Inventors: Harry Francis Shultz, III, Glenmoore, PA (US); Jennifer Kurtz, Audubon, PA (US); Chris Avenick, Audubon, PA (US); Stephen Tudor, Audubon, PA (US); Abraham Walters, Waynesboro, PA (US)

(21) Appl. No.: 18/867,192

(22) PCT Filed: May 19, 2023
(86) PCT No.: PCT/US2023/067264

§ 371 Date: Nov. 19, 2024

Related U.S. Application Data
(60) Provisional application No. 63/344,483, filed on May 20, 2022.
(60) Provisional application No. 63/344,613, filed on May 22, 2022.

(51) Int. Cl. G06Q 10/0635

(52) U.S. Cl. CPC G06Q 10/0635

(57) ABSTRACT

An event monitor engine receives incoming event information from a plurality of information sources. An event data mining engine executes a data-mining algorithm on the raw event information to produce a structured output of event information from the plurality of information sources in a common event-information format. An organization information structuring engine receives information about an organization from a plurality of different business systems of the organization, and creates a structured organization description that includes information about resources of the organization in a common format. A threat assessment engine applies threat assessment criteria to the structured out-put of the event information and to the structured organization description to produce an event-resource assessment of whether an event is likely to impact a resource of the organization. A response advisor engine determines a response recommendation for each event-resource assessment based on response criteria, and outputs the response recommendation to be displayed.

### PRIOR APPLICATIONS

This Application claims the benefit of U.S. Provisional Application No. 63/344,483 filed May 20, 2022, and U.S. Provisional Application No. 63/344,613 filed May 22, 2022, the disclosures of which are incorporated by reference herein.

### TECHNICAL FIELD

The present subject matter relates generally to information technology and computer networks and, more particularly, to systems and methods for to preparing, monitoring, communicating, and responding to critical threats faced by organizations.

### BACKGROUND

Business organizations face a constant barrage of challenges from the dynamic and unpredictable world in which they operate. These include supply chain disruptions, cyber-attacks, pandemics, natural disasters, social unrest, political instability, and much more. Climate change is expected to drive increasingly severe weather events, and geopolitical tensions are impacting global workforces, facilities, and supply chains. Social unrest and violence continues in many forms throughout the U.S. and abroad.

Conventional organizational resilience technologies encompass a range of tools and strategies that enable businesses to adapt and recover in the midst of disruptions. These technologies include advanced data backup and recovery systems, cloud computing, virtualization, and real-time monitoring systems. For instance, cloud computing provides organizations with scalable and on-demand computing resources, allowing them to store critical data off-site and quickly restore operations in the event of a disaster. Virtualization enables the rapid deployment of virtual machines, facilitating efficient disaster recovery and minimizing downtime. Real-time monitoring systems monitor network infrastructure, detect anomalies, and facilitate proactive responses to potential disruptions.

Investing in organizational resilience technologies offers several benefits to organizations. Firstly, it reduces the risk of data loss and ensures the continuity of operations, even in the face of severe disruptions. This enhances customer trust and loyalty while minimizing financial losses associated with downtime. Secondly, it enables organizations to adapt quickly to changing circumstances and capitalize on opportunities that arise from unexpected events. Moreover, these technologies and methods enhance overall organizational preparedness, as they facilitate risk assessment, business impact analysis, and the development of robust contingency plans.

Up to this point, an effective integrated end-to-end system for setting up and managing organizational resilience has not been deployed. Instead, organizations have had to piece together disparate tools and systems with the aim of implementing their resilience policies. Typically, the result of this effort is an ad-hoc approach that relies more on human expertise and reactionary management than on a structured, comprehensive technology that autonomously recognizes emergent risks and proactively adapts to the changing threat environment. A practical solution which offers the latter is needed.

### SUMMARY OF THE DISCLOSURE

In some aspects, the techniques described herein relate to a system for facilitating organizational resilience, including: an event monitor engine having an input to receive incoming event information from a plurality of near-real-time information sources, the event monitor engine operative to store raw event information; an event data mining engine communicatively coupled to the event monitor engine, the event data mining engine operative to execute a data-mining algorithm on the raw event information to produce a structured output of event information from the plurality of information sources in a common event-information format; an organization information structuring engine having an input to receive information about an organization from a plurality of different business systems of the organization, the organization information structuring engine operative to create a structured organization description that includes information about resources of the organization in a common organization-information format; a threat assessment engine communicatively coupled to the event data mining engine and to the organization information structuring engine, the threat assessment engine operative to apply threat assessment criteria to the structured output of the event information and to the structured organization description to produce an event-resource assessment of whether an event is likely to impact a resource of the organization; and a response advisor engine communicatively coupled to the threat assessment engine, the response advisor engine operative to determine a response recommendation for each event-resource assessment based on response criteria, and to output the response recommendation to be displayed via a graphical user interface.

In some aspects, the techniques described herein relate to an automated method for facilitating organizational resilience, including: by an automated system, receive incoming event information from a plurality of near-real-time information sources and storing raw event information; by the automated system, executing a data-mining algorithm on the raw event information to produce a structured output of event information from the plurality of information sources in a common event-information format; by the automated system, receiving information about an organization from a plurality of different business systems of the organization and creating a structured organization description that includes information about resources of the organization in a common organization-information format; by the automated system, applying threat assessment criteria to the structured output of the event information and to the structured organization description to produce an event-resource assessment of whether an event is likely to impact a resource of the organization; and by the automated system, determining a response recommendation for each event-resource assessment based on response criteria, and outputting the response recommendation to be displayed via a graphical user interface.

In some aspects, the techniques described herein relate to at least one non-transitory machine-readable storage medium containing instructions that, when executed on a computing system, causes the computing system to: receive incoming event information from a plurality of near-real-time information sources and storing raw event information; execute a data-mining algorithm on the raw event information to produce a structured output of event information from the plurality of information sources in a common event-information format; receive information about an organization from a plurality of different business systems of the organization and create a structured organization description that includes information about resources of the organization in a common organization-information format; apply threat assessment criteria to the structured output of the event information and to the structured organization description to produce an event-resource assessment of whether an event is likely to impact a resource of the organization; and determine a response recommendation for each event-resource assessment based on response criteria, and output the response recommendation to be displayed via a graphical user interface.

### BRIEF DESCRIPTION OF THE DRAWINGS

The invention may be more completely understood in consideration of the following detailed description of various embodiments of the invention in connection with the accompanying drawings, in which:

FIG. 1 is a simplified block diagram illustrating, at an overview level, an organization-resilience management system according to some embodiments.

FIG. 2 is a diagram illustrating an exemplary hardware and software architecture of a computer system on which aspects of the embodiments described above may be implemented, and in which various interfaces between hardware components and software components are shown according to an example.

FIG. 3 is a diagram illustrating an example of a system architecture according to an embodiment.

FIGS. 4A-4B illustrate a service deployment example in greater detail.

FIG. 5 illustrates an example implementation of a big-data architecture supporting threat intelligence data aggregation according to an embodiment.

FIG. 6 is an example overview display showing a map with locations of various events and a high-level summary of the scale of the impact on the organization of those events, according to an example.

FIG. 7 shows a display screen listing of various threats, and their categorizations, according to an example.

FIG. 8 shows a display screen listing active incidents that are applicable to the organization, according to an example.

FIG. 9 shows a display screen of a critical incident, namely, a power outage, according to an example.

FIG. 10 shows a display screen of an event command center according to an example implementation.

FIG. 11 shows a display screen of a user interface for viewing and editing details of the organization, according to an example.

FIG. 12 shows a display screen in which various personnel are assigned to corresponding functions for purposes of incident responding, according to an example.

FIG. 13 shows a display screen of a recovery plan-checklist view in which recovery objectives and response strategies may be entered and edited, according to an example.

FIG. 14 shows a display screen with a list of pre-configured recovery plans for different types of incidents, which may be organized and edited, according to an example.

FIG. 15 is a flowchart of an example method for an automated method for facilitating organizational resilience according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DESCRIPTION

Aspects of the embodiments are directed to a comprehensive enterprise resilience platform. In the present context, an enterprise resilience platform is a networked information system which supports business continuity (BC), threat intelligence, incident response, disaster recovery (DR), risk management, critical event management, and compliance and audit operations. Business continuity refers to system operations that support an end-to-end resilience/recovery program including business intelligence and analysis (BIA), business continuity and disaster-recovery planning, exercising and reporting. Incident response includes automated response orchestration and execution of dynamic responses which vary with the monitored circumstances. An event command center may be provided which serves event participants, event leaders, observers, and executive stakeholders. Threat intelligence proactively monitors, with near-real-time intelligence feeds, threats from hundreds of sources as they relate to an organization's locations, severity levels, and proximity to key sites. Notifications ensure personnel are protected by communicating to targeted audiences via multiple channels. Incident management takes action by in-solution recovery and response orchestration.

The enterprise resilience platform may be implemented as part of a computer system. The computer system may be one physical machine, or may be distributed among multiple physical machines, such as by role or function, or by process thread in the case of a cloud computing distributed model. In various embodiments, aspects of the invention may be configured to run in virtual machines that in turn are executed on one or more physical machines. It will be understood by persons of skill in the art that features of the invention may be realized by a variety of different suitable machine implementations.

Generally, the system includes various engines, each of which is constructed, programmed, configured, or otherwise adapted, to carry out a function or set of functions, as detailed below. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

In examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

### System Overview

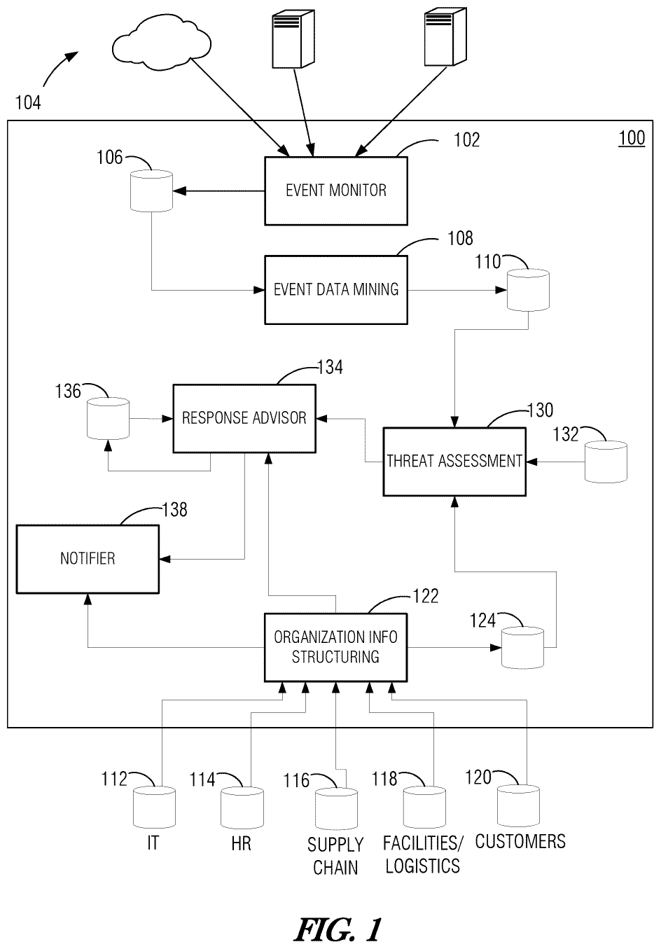

FIG. 1 is a simplified block diagram illustrating, at an overview level, an organization-resilience management system according to some embodiments. As depicted, system 100 includes event monitor engine 102, which communicates with a plurality of information sources 104 that supply near-real-time information about events of interest. Such events may include, without limitation, weather events or natural disasters, power or communications outages or disruptions, cyberattacks, political or civil unrest, or the like. Information sources 104 may be Internet-based, such as news feeds, social-media content, subscription services, or via other communications channels, such as radio/TV media broadcasts, satellite link, etc. Event monitor engine 102 includes all suitable communications and network-interface circuitry to obtain information from information sources 104. Gathered raw data from information sources 104 is stored in database 106. The raw event data may be in disparate formats from the different sources 104.

Event data mining engine 108 reads and parses the raw event data from database 106, extracts key event data, and generates a structured output representing events from the multiple information sources in a uniform format, which may be tagged, classified, clustered, or otherwise interpreted. The structured output may be stored in structured event database 110. Event data mining engine may perform rules-based, heuristic, or machine-learning (ML)-based processing of the raw event data. Event data mining engine 108 may perform classification, clustering, association rule mining, or other suitable data-mining algorithm. In related embodiments, event data mining engine 108 includes a deep neural network which is trained to classify event data.

Threat assessment engine 130 processes the structured event data stored in structured event database 110 to determine a threat assessment as it relates specifically to the organization. To this end, threat assessment engine 130 obtains structured information about the organization that is generated by organization information structuring engine 122.

Organization information structuring engine 122 receives information about the organization from a plurality of disparate sources in various formats, and structures this information for use by threat assessment engine 130. Examples of sources of information about the organization include, without limitation, information technology (IT) systems 112 (e.g., network graphs, internal and externally-facing servers, subnetworks and gateways, etc.), cybersecurity systems such as intrusion protection systems (IPSs), firewalls, sandboxes, antivirus systems and services, cloud services, and the like. Personnel data may be fed from a human-resources (HR) system 114, including organization hierarchy functions, names and contact information of key personnel, their location, etc. Supply chain information 116 may include information about the organization's suppliers (names, locations, key individuals, goods/materials supplied, etc.). Facilities/logistics information 118 may include information about the organization's offices, factories, warehouses, and other facilities, as well as transportation providers, transport routes, etc. Customer information 120 includes names, locations, and key personnel of customers, distributors, partners/collaborators, and other entities in the distribution chain, along with associated products that these entities receive from the organization.

Organization information structuring engine 122 reads and parses all of the organization-related information from the various sources, and creates a structured organization description with pertinent information about the organization's resources, to be stored in organization database 124. The organization information may be grouped, categorized, tagged, or otherwise organized in a way that is suitable for use by threat assessment engine 130.

Threat assessment engine 130 applies assessment criteria 132 to the structured event data to determine whether any events constitute actionable threats, or incidents. To this end, assessment criteria 132 may include rules, heuristics, ML, or other suitable algorithm(s) that determine whether any event impacts any portion of the organization, and in what way.

In some embodiments, threat assessment engine 130 ranks and prioritizes the threats based on their impact to the organization. In one type of embodiment, a criticality score is automatically computed according to criticality scoring criteria, which may be part of assessment criteria 132, for each threat-resource pair based on that threat's impact on various aspects of the organization. For instance, events impacting a resource that may adversely affect the organization's finances, operations, reputation/good will, or regulatory compliance or legal liability, may be numerically scored in each of these categories. A single criticality score may be derived based on the category scores. For example, a sum of the impact score for each category may be computed as the single criticality score which is associated with an event and impacted resource of the organization. Use of the criticality scores can advantageously improve the system's computational efficiency. In particular, criticality-score-based prioritization allows system 100 to omit further processing and reporting of certain events. This frees up computational resources, particularly, compute, memory, and output facilities, to focus on responding to the most critical events.

In a related embodiment, in addition to the criticality score, a risk index may be determined for each resource of the organization. The risk index may be computed automatically based on historical data about each resource, such as frequency of events which impact that resource, recovery time, cost of abatement or recovery when that resource is affected, etc. The risk index may be used as a measure of susceptibility of a particular resource to an adverse event. In some embodiments, resources with higher risk indexes may be prioritized in the threat assessment processing to be preferentially assessed ahead of other resources in response to an event.

In some embodiments, the output of threat assessment engine 130 is a data structure, or stream of data, which associates an event with an impacted resource of the organization, and an assessment of the degree of the impact, such as a criticality score. This output is passed to response advisor engine 134.

Response advisor engine 134 determines, for each event-resource combination deemed a threat by threat assessment engine 130, a recommendation for responding to the event deemed a threat, and assigns specific action(s) to specific individual(s) of the organization. The response recommendations generated by response advisor engine 134 may be based on response plans and other decision criteria, which may be stored in response database 136. Response plans may be planned a priori, and may be specific to each resource and event type. In other examples, response plans may be based on past incidents, or on predefined criteria. In some embodiments, response plans are dynamically generated specific to a present threat and affected resource according to a knowledge base (e.g., expert system) or trained classifier, such as a ML engine. The determined response recommendations may be saved in response database 136, which may, in turn, be used to further develop threat assessment criteria 132, and response plans for future incidents.

Further, the determined response recommendations may be passed to notifier engine 138 to be communicated to the assigned personnel. Notifier engine may be implemented a mass-notification system such as the ones described in co-pending U.S. patent application Ser. No. 17/503,114, the disclosure of which is incorporated by reference herein. In a related embodiment, only key personnel are notified, and different sets of details may be provided in those notifications to those personnel. For example, personnel at a particular facility that is in the path of a severe weather event may be notified with instructions to take shelter, move certain equipment, prepare the building, arrange for backup power, etc., whereas personnel at the organization's main office may be notified about the event and its potential impact on production or deliveries to customers. In this way, notifications may be location-specific, and function-specific.

### Underlying Computing Architecture

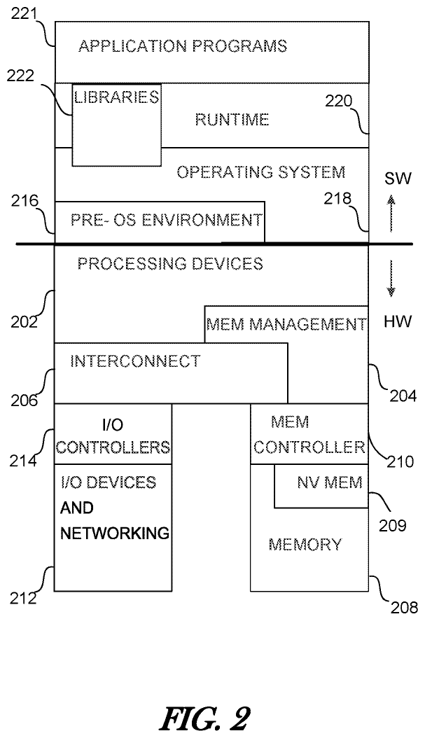

FIG. 2 is a diagram illustrating an exemplary hardware and software architecture of a computer system on which aspects of the embodiments described above may be implemented, and in which various interfaces between hardware components and software components are shown according to an example. As indicated by HW, hardware components are represented below the divider line, whereas software components denoted by SW reside above the divider line. On the hardware side, processing devices 202 (which may include one or more microprocessors, digital signal processors, etc., each having one or more processor cores, are interfaced with memory management device 201 and system interconnect 206. Memory management device 201 provides mappings between virtual memory used by processes being executed, and the physical memory. Memory management device 201 may be an integral part of a central processing unit which also includes the processing devices 202.

Interconnect 206 includes a backplane such as memory, data, and control lines, as well as the interface with input/output devices, e.g., PCI, USB, etc. Memory 208 (e.g., dynamic random access memory-DRAM) and non-volatile memory 209 such as flash memory (e.g., electrically-erasable read-only memory—EEPROM, NAND Flash, NOR Flash, etc.) are interfaced with memory management device 201 and interconnect 206 via memory controller 210. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 212, which interface with interconnect 206 via corresponding I/O controllers 211.

On the software side, a pre-operating system (pre-OS) environment 216, which is executed at initial system start-up and is responsible for initiating the boot-up of the operating system. One traditional example of pre-OS environment 216 is a system basic input/output system (BIOS). In present-day systems, a unified extensible firmware interface (UEFI) is implemented. Pre-OS environment 216 is responsible for initiating the launching of the operating system, but also provides an execution environment for embedded applications according to certain aspects of the invention. Operating system 218 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 218 provides device drivers, and a variety of common services such as those that facilitate interfacing with peripherals and networking, that provide abstraction for application programs so that the applications do not need to be responsible for handling the details of such common operations. Operating system 218 additionally provides a graphical user interface (GUI) that facilitates interaction with the user via peripheral devices such as a monitor, keyboard, mouse, microphone, video camera, touchscreen, and the like.

Runtime system 220 implements portions of an execution model, including such operations as putting parameters onto the stack before a function call, the behavior of disk input/output (I/O), and parallel execution-related behaviors. Runtime system 220 may also perform support services such as type checking, debugging, or code generation and optimization.

Libraries 222 include collections of program functions that provide further abstraction for application programs. These include shared libraries, dynamic linked libraries (DLLs), for example. Libraries 222 may be integral to the operating system 218, runtime system 220, or may be added-on features, or even remotely-hosted. Libraries 222 define an application program interface (API) through which a variety of function calls may be made by application programs 221 to invoke the services provided by the operating system 218. Application programs 221 are those programs that perform useful tasks for users, beyond the tasks performed by lower-level system programs that coordinate the basis operability of the computer system itself.

### Enterprise Architecture

One aspect of the embodiments is directed to a web application that is built on top of an event-driven microservice architecture. An API Gateway governs who can get access to the data stored in the microservices.

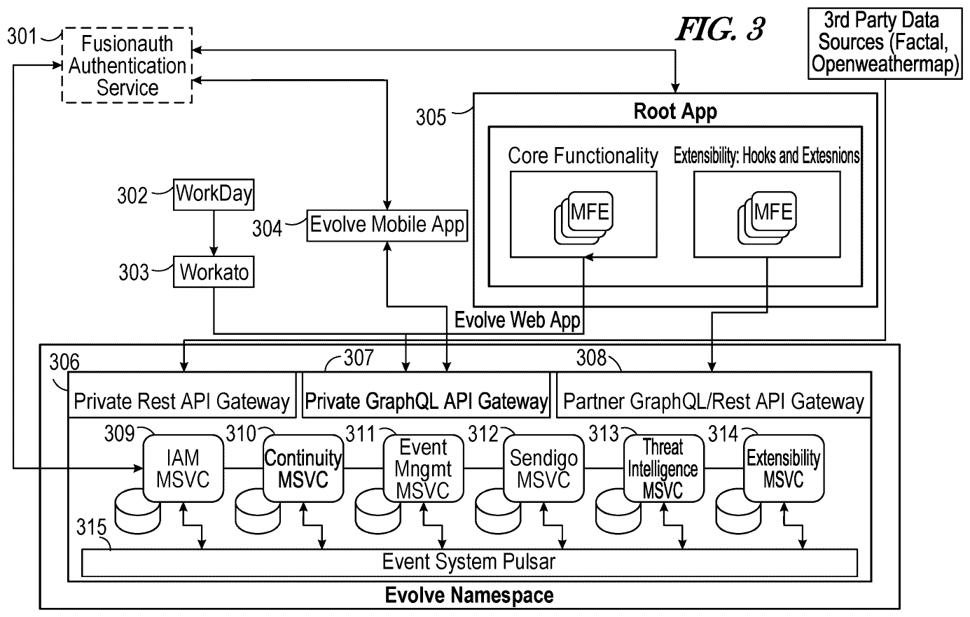

FIG. 3 is a diagram illustrating an example of a system architecture according to an embodiment. The numbered items are described below.

301. FusionAuth is a cloud-based service provider that provides authN and authZ capabilities. They handle the login and logout functionality of the website.

302. Most of the system's clients will store their employee data in a human-resources suite such as WorkDay. Here is shown to integrate with their instance of WorkDay® through Workato to get their employee data in the services.

303. Workato is a 3rd party solution that allows applications of the platform to connect to external third-party applications through connectors. Multiple connectors may be provided to the clients to allow them to connect to different applications to get not only employee data, but resource data as well.

304. The native mobile app provides solutions to specific use cases separate from the web application. The mobile app interacts with the platform's services through the same API Gateway.

305. The web application is made up of multiple mini React applications referred to as micro frontends (MFEs). The orchestration of these MFEs is handled through a root application. A javascript framework called Single Spa handles this orchestration. Each MFE has its own repository and deployment process. A MFE has multiple routes boundaries are set to be specific sections of the site, like threats.

306. A private REST API Gateway allows outside services, both third-party and MFEs, to access specific REST endpoints on the platform's services that are outside the GraphQL supergraph. These endpoints include file uploads, subscription data source endpoints used for push notifications from data source providers, and unauthorized endpoints that MFEs may hit.

307. A private Graphql API Gateway allows MFEs to communicate with a microservice's APIs. Each one of the microservices has a Graphwl schema. The gateway contains a super graph that incorporates each one of the service's schema. The gateway may be implemented using Apollo Federated. This is third-party code that is hosted in the platform's environment. The gateway handles all authentication, not allowing a consumer to access the services without a valid token.

308. Partner GraphQL API Gateway is available for customers to use with the appropriate permissions so that they can access the data and update it through the API. This gateway may be implemented as REST or GraphQL.

309. The IAM service handles all authn and authz requests. It stores organization data and people data and the releted user ids of users stored in FusionAuth. The service also stores all available permissions and each organization's security groups. These security groups are user created and are a roll up of multiple permissions that can be assigned to a user.

310. The continuity microservice stores all resource, team, and location data. Each resource contains specific data that is used to determine how it is recovered in the event of an incident. Criticality Score is one of these pieces of data.

311. The Event Management microservice stores its data in a graph database. It stores copies of all resources in an organization with the purpose of traversing the complicated dependencies to figure out what resources are impacted in the moment of an incident. The service stores incidents, plans, and exercises. The service also has the logic of a workflow engine, which is an asynchronous process that keeps track of a step by step workflow.

312. The Sendigo Mircorservice represents multiple services that make up the Sendigo mass notification Engine. This engine also facilitates the Sendigo app.

313. The threat Intelligence micro service represents multiple services as well. It includes an ingress service that collects data from external sources, as well as a threat service that contains the algorithms to determine if a threat is relevant to an organization.

314. Our extensibility microservice stores customizations to the core logic. The extensibility microservice may allow customers to add custom scripts to hooks within the event system. In addition, the extensibility microservice allows customers to create their own MFEs and stores the registration and configurations in this service.

315. The event system may be implemented using Apache Pulsar. Micro Services do not directly communicate with each other to avoid point to point integrations, which would cause tight couplings. Instead, every micro service subscribes to the topics they are concerned about through Pulsar to get the data they need.

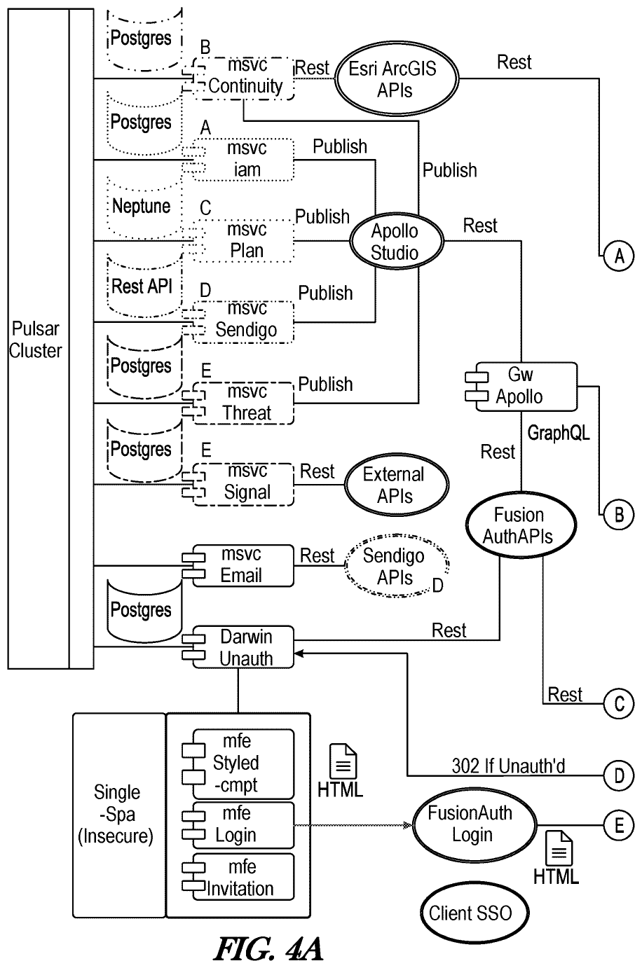

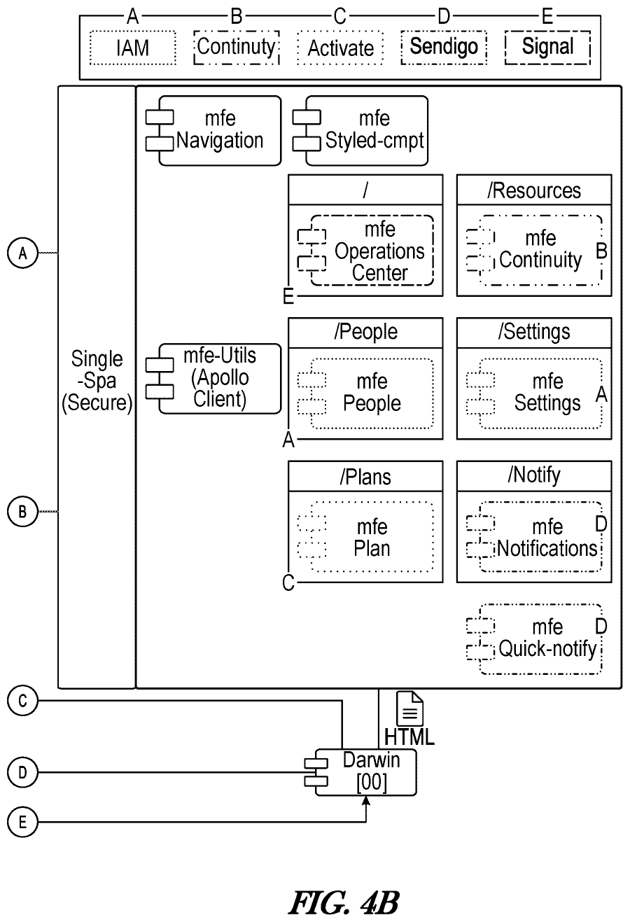

FIGS. 4A-4B illustrate a service deployment example in greater detail.

### Event Management

In various embodiments, the automated determination of priority/precedence (including recovery time objective (RTO) determination/aggregation and dynamic updating of recovery time actual (RTA)) provides a dynamic aggregation of response steps according to these determinations. The determination may be performed based on logical rules, heuristic algorithm, machine-learning engine, etc. During an incident, the application pulls in response tasks from existing plans tailored to the specifics of the incident. This process may utilize a recommendations engine leveraging machine learning. The learning is on the data captured from plans created by the organization and past incidents to understand the usage and priority of responses.

In some embodiments, the system allows clients to store assets and resources that they ultimately will want to recover in case of an incident. In one example, this is accomplished by storing specific data points on each resource that allows the system to determine how critical it is to the organization and what steps should be followed to recover it. When a threat comes in and is determined it is impactful to the organization, the system instantly queries all the organization's resource data to determine all resources that are impacted by the threat and which recovery strategies should be used to recover these resources. This resource data may be stored in a graph database that can be quickly queried and navigated along its complex dependency paths using the power of graph databases. This allows the system to create incidents quickly and begin executing recovery steps instantly, allowing an organization to recover from an incident as soon as possible. The system uses a workflow engine to step through each task that needs to be completed, with some tasks being automated, some manual, until each task is completed and the resources are recovered.

### Automated Compliance Evaluation

Utilities for automated compliance evaluation, in part through leveraging AI so that implementations can, with reasonable degrees of confidence, reduce manual efforts to document compliance. This may take place within a semi-automated framework that accommodates different customer compliance standards, such as various ISO standards. These are unique to organizations, so standards data is loaded into the application, tailored to organization-defined priorities, and then the application applies dynamic incident data to determine compliance.

### Embedded Employee Data Integration

By utilizing an iPaas solution like Workato, the system has access to hundreds of enterprise level apps to integrate with, and their marketplace continues to grow. As part of the solution according to some embodiments, the employee data API is embedded within the solution for administrations to select to initiate, providing real-time employee updates critical for incident response and mass notification.

### Know Your Business Guided Data Aggregation

A synopsis completed of a specific business entity's operations, what is needed to be successful, who is involved, and what processes are upstream and downstream. The guided data aggregation addresses duplication, ties workflows, etc. This may be handled through the front-end application wizard and database, and not specific to the architecture.

### Criticality Score

Criticality Score measures the impact to the business if the resource is not available. Criticality score tells us how it should be prioritized when brought into an action plan, providing the prioritization unique to the incident. The score is measured over time to show how the impact might change. For the final score calculation, the highest value over the 0-5+ day period is captured

If:
Financial
Operational
Brand/Reputational
Compliance/Legal

Total criticality score=Sum of highest value from each impact type provided

In certain embodiments, the criticality score is applied to improve the functionality (e.g., speed, responsiveness, compute efficiency, and reliability) of the system. For instance, in some implementations, the system computes the criticality score for each of the resources and, based on the criticality score, responses to incidents, such as data recovery, network protection, notifications, etc., are processed preferentially in order of criticality score (highest to lowest) automatically focusing computing resources onto the most critical resources.

In related embodiments, task scheduling of responses to incidents includes tasks that are processed in serial fashion, and tasks that may be interleaved with other tasks. The criticality score may be used to schedule such incident-response tasks such that tasks corresponding to high-criticality resources (e.g., exceeding a defined criticality score threshold) are processed in serial fashion, whereas tasks corresponding to low-criticality resources (e.g., having a criticality score below a defined threshold) may be interleaved with other tasks. In related implementations, a graded scheduling scheme may be utilized in which a fractional share of computing-resource allocation may be assigned to tasks based on their respective corresponding criticality scores.

In another related approach that may be used in distributed-processing arrangements having multiple processing nodes, a relatively greater number of processing nodes may be allocated to high-criticality-score tasks, whereas relatively fewer processing nodes may be allocated to low-criticality-score tasks.

In a related embodiment, low-criticality-score tasks are not processed until high-criticality-score tasks are completed.

### Threat Intelligence Data Aggregation

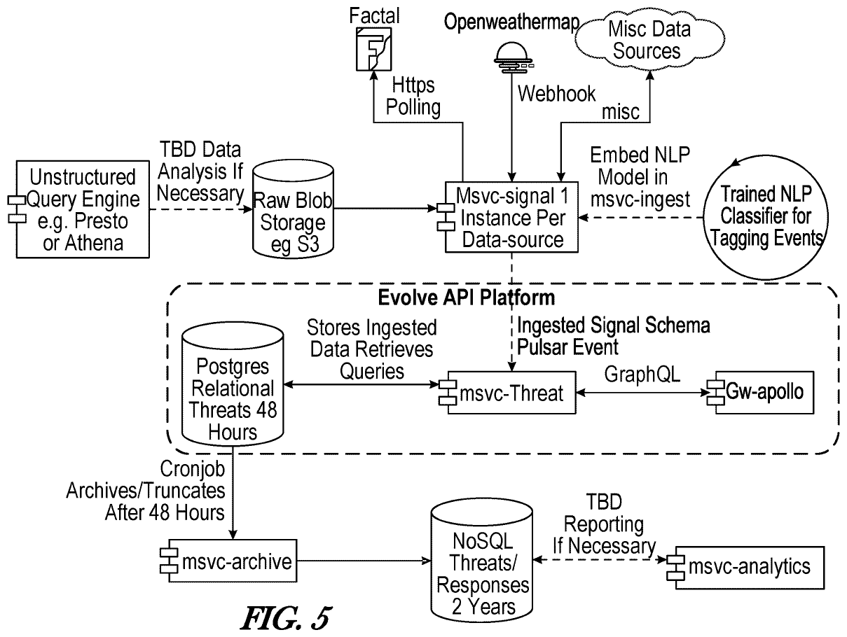

In some embodiments, the system hooks up to multiple data sources that provide threat data (Open WeatherMap, Factal). The data is then converted into a specific data model on which a trained ML system may be used to determine the category and potential clustering of data from multiple sources. The system runs the threat data against calculations to determine if the threat is relevant to any of the organization's resources. If so, key personnel will get notifications and be able to view the threat within the app. The system may receive a lot of threat data from all over the world. The solution is architected to support big data and hold on to the raw data so that ML and other advanced algorithms may be executed to provide customers with insights based on trends. FIG. 5 illustrates an example implementation of a big-data architecture supporting threat intelligence data aggregation according to an embodiment.

Additionally, some embodiments provide a framework that automatically creates a response with the organization's data at the time of a threat. This enables teams to spend less time planning for all possible scenarios and have a more comprehensive & dynamic response strategy. Through external APIs this can drive automated actions (as mentioned in automated plan generation, but based on external intelligence data).

### Graphical User Interface Examples

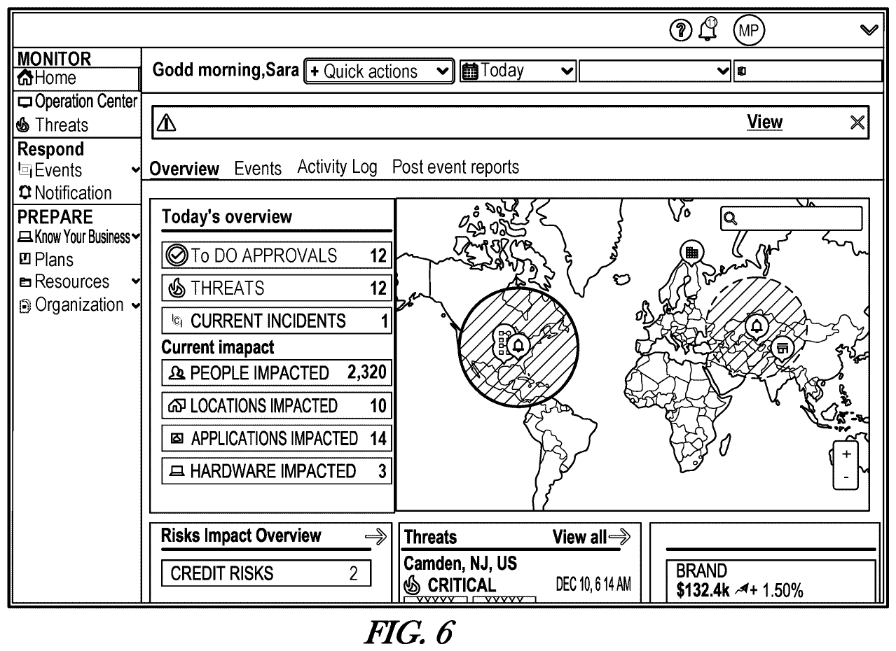

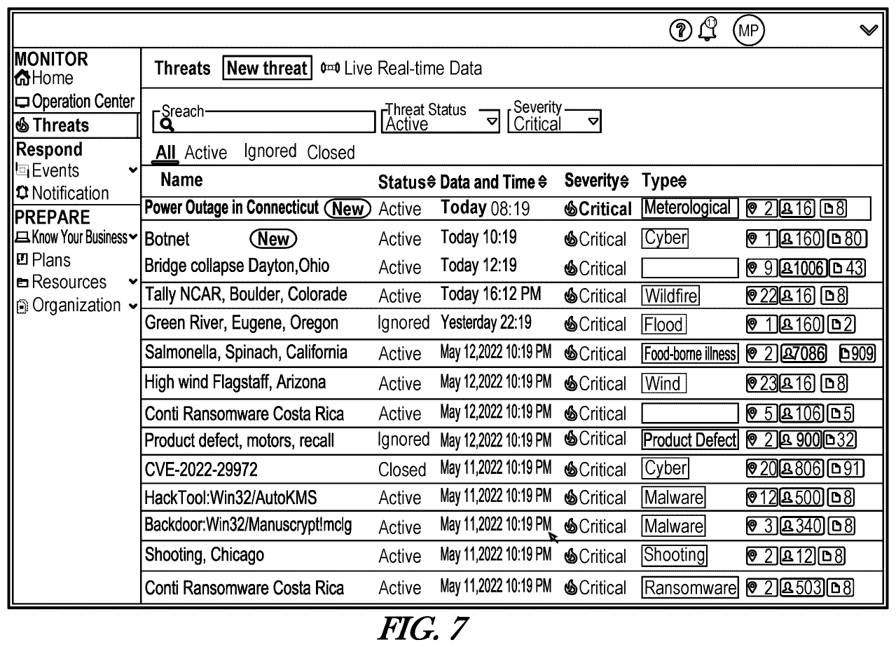

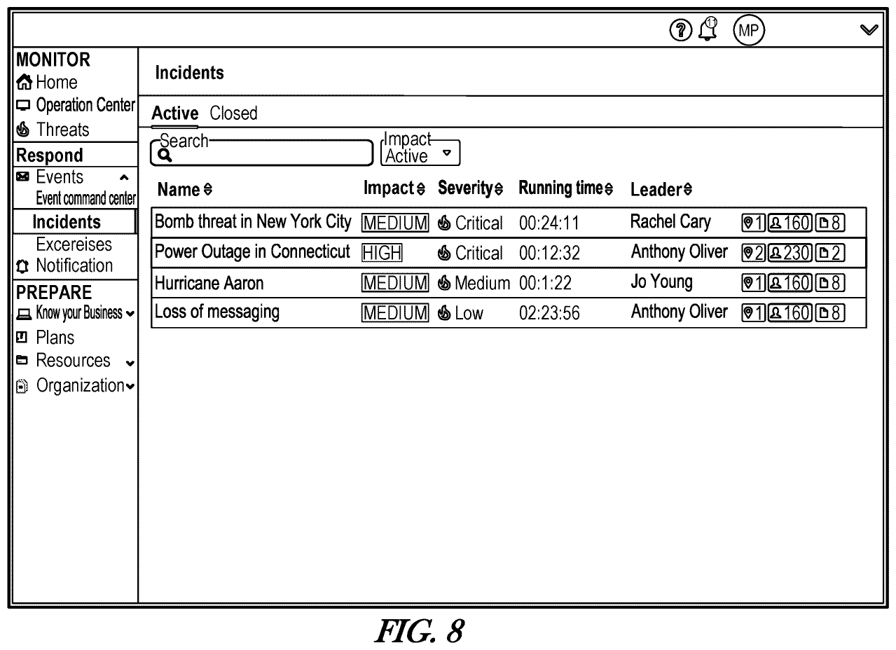

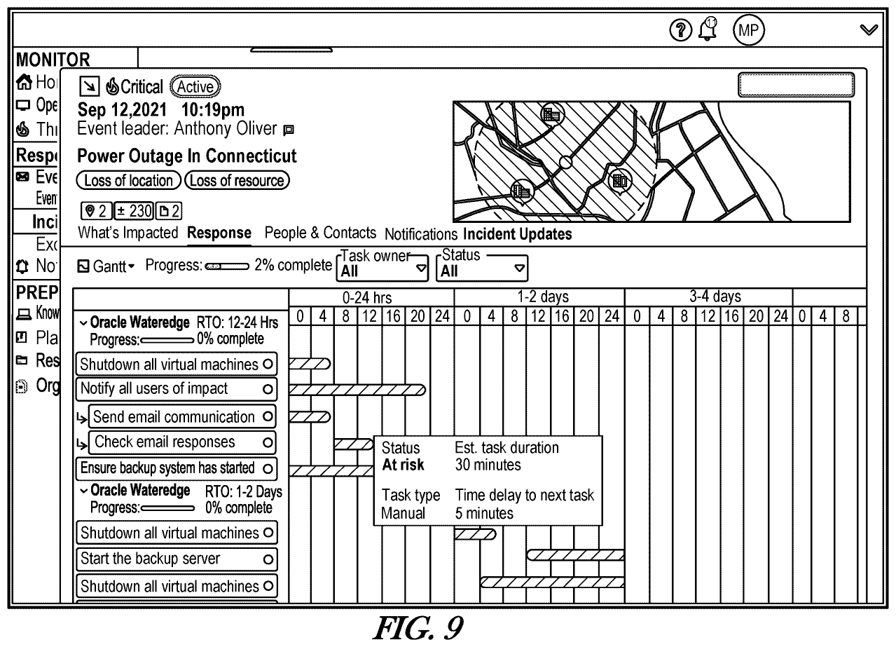

FIGS. 6-14 illustrate various aspects of the system's functionality by way of the user interface. FIG. 6 is an example overview display showing a map with locations of various events and a high-level summary of the scale of the impact on the organization of those events. FIG. 7 shows a display screen listing of various threats, and their categorizations. FIG. 8 shows a display screen listing active incidents that are applicable to the organization. The impact, severity, running time, and assigned personnel are indicated for each incident. FIG. 9 shows a display screen of a critical incident, namely, a power outage. A series of recommended responses is shown, as generated by the system, with progress indicia for each response.

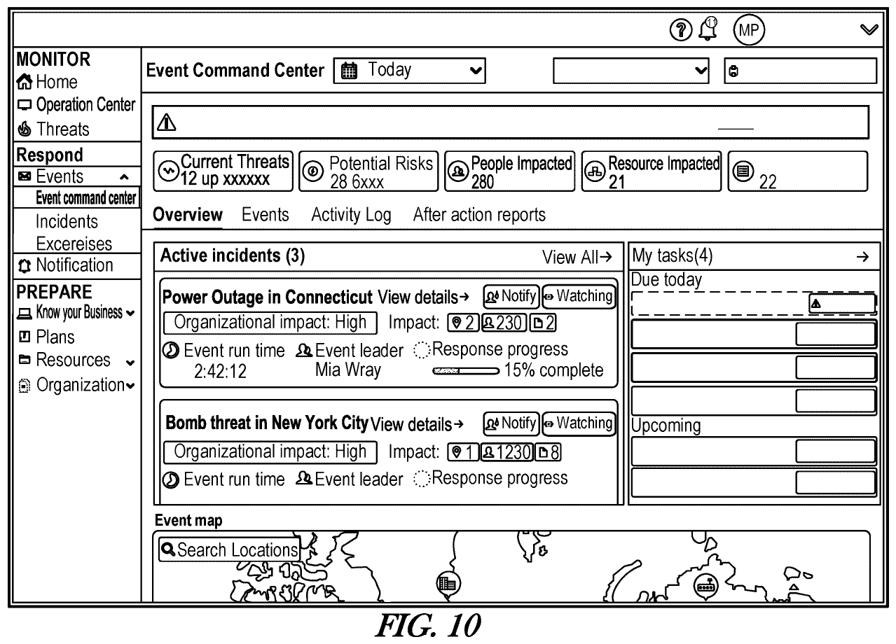

FIG. 10 shows a display screen of an event command center according to an example implementation. Active incidents are shown with several details, including the assessed organizational impact, the assigned event leader, the response progress, and the event run time.

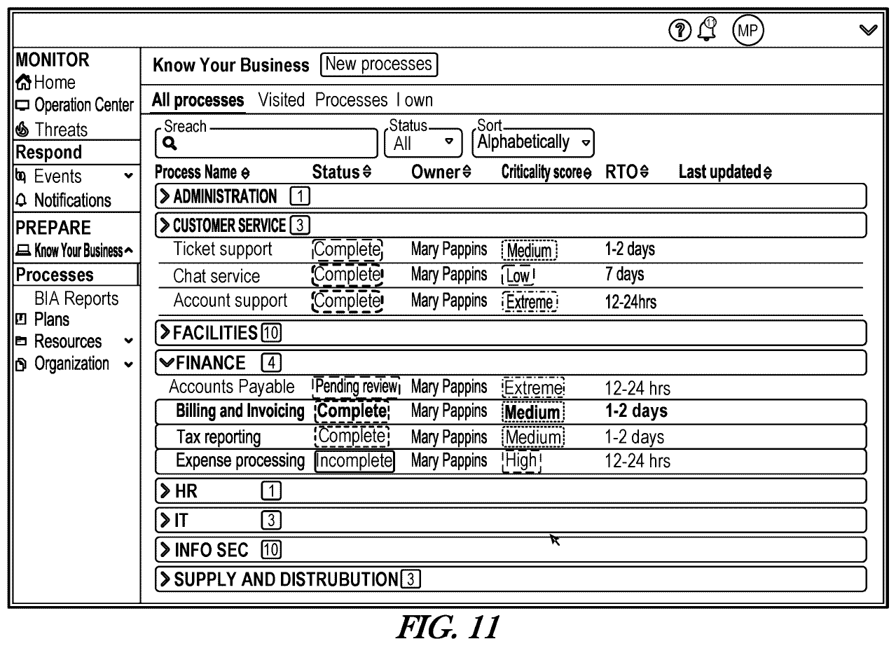

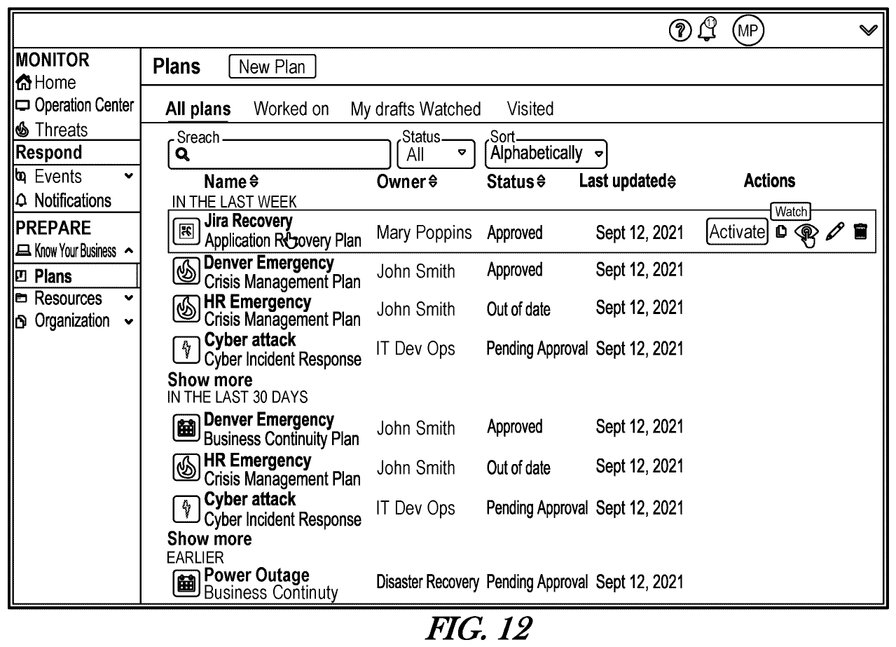

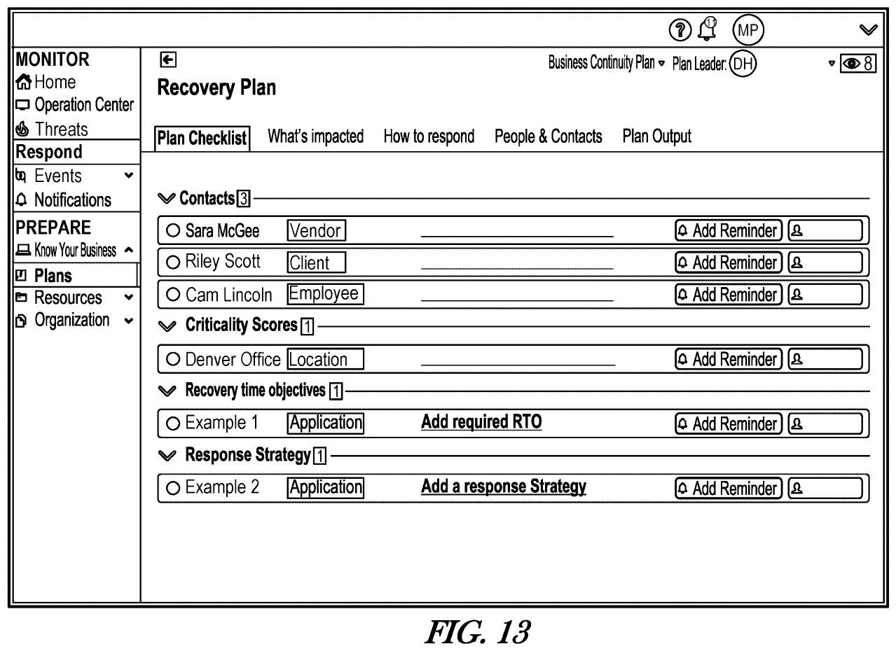

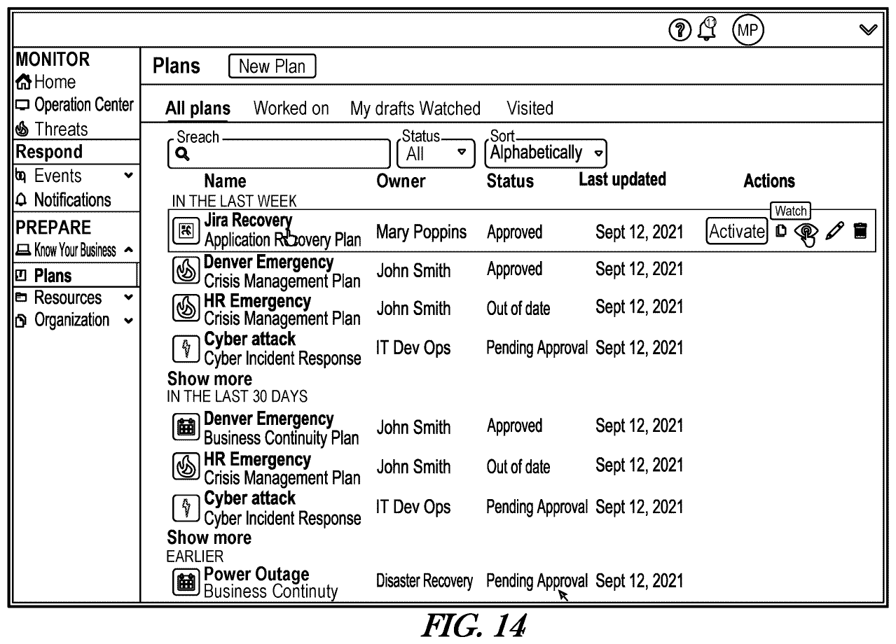

FIG. 11 shows a display screen of a user interface for viewing and editing details of the organization. As shown, the user may add details regarding administration, customer service, facilities, finance, HR, IT, information security, and supply and distribution operations. FIG. 12 shows a display screen in which various personnel are assigned to corresponding functions for purposes of incident responding. FIG. 13 shows a display screen of a recovery plan-checklist view in which recovery objectives and response strategies may be entered and edited. FIG. 14 shows a display screen with a list of pre-configured recovery plans for different types of incidents, which may be organized and edited.

### Method Operations

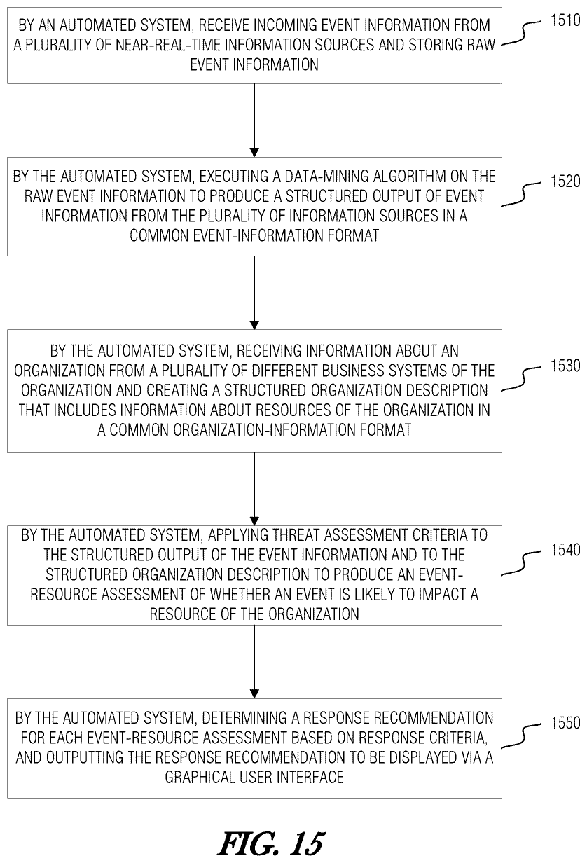

FIG. 15 is a flowchart of an example method for an automated method for facilitating organizational resilience according to an embodiment. At 1510 an automated system receives incoming event information from a plurality of near-real-time information sources and stores raw event information. At 1520 the automated system executes a data-mining algorithm on the raw event information to produce a structured output of event information from the plurality of information sources in a common event-information format. At 1530, the automated system receives information about an organization from a plurality of different business systems of the organization and creates a structured organization description that includes information about resources of the organization in a common organization-information format. At 1540 the automated system applies threat assessment criteria to the structured output of the event information and to the structured organization description to produce an event-resource assessment of whether an event is likely to impact a resource of the organization. At 1550 the automated system, determines a response recommendation for each event-resource assessment based on response criteria, and outputs the response recommendation to be displayed via a graphical user interface.

### Additional Notes and Examples

Example 1 is a system for facilitating organizational resilience, comprising: an event monitor engine having an input to receive incoming event information from a plurality of near-real-time information sources, the event monitor engine operative to store raw event information; an event data mining engine communicatively coupled to the event monitor engine, the event data mining engine operative to execute a data-mining algorithm on the raw event information to produce a structured output of event information from the plurality of information sources in a common event-information format; an organization information structuring engine having an input to receive information about an organization from a plurality of different business systems of the organization, the organization information structuring engine operative to create a structured organization description that includes, information about resources of the organization in a common organization-information format; a threat assessment engine communicatively coupled to the event data mining engine and to the organization information structuring engine, the threat assessment engine operative to apply threat assessment criteria to the structured output of the event information and to the structured organization description to produce an event-resource assessment of whether an event is likely to impact a resource of the organization; and a response advisor engine communicatively coupled to the threat assessment engine, the response advisor engine operative to determine a response recommendation for each event-resource assessment based on response criteria, and to output the response recommendation to be displayed via a graphical user interface.

In Example 2, the subject matter of Example 1 includes, wherein the event monitor engine is operative to store the raw event information in formats provided by the respective information sources.

In Example 3, the subject matter of Examples 1-2 includes, wherein the threat assessment engine is operative to compute a criticality score that represents a degree of impact that an event is likely to have upon a resource of the organization.

In Example 4, the subject matter of Example 3 includes, wherein the response advisor engine is operative to de-prioritize processing of event-resource assessments that have relatively lower criticality scores in favor of processing other event-resource assessments that have relatively higher criticality scores.

In Example 5, the subject matter of Examples 3-4 includes, wherein the criticality score is a single value that is computed from a plurality of categorized impact scores.

In Example 6, the subject matter of Examples 3-5 includes, wherein the threat assessment engine is operative to compute a risk index for a resource of the organization based on historical data about that resource, the risk index representing a measure of susceptibility that resource has to events.

In Example 7, the subject matter of Examples 1-6 includes, a notifier engine communicatively coupled to the response advisor engine and to the organization information structuring engine, the notifier engine operative to generate notifications to specific personnel of the organization that are assigned responsibility for responding to event-resource incidents.

Example 8 is an automated method for facilitating organizational resilience, comprising: by an automated system, receive incoming event information from a plurality of near-real-time information sources and storing raw event information; by the automated system, executing a data-mining algorithm on the raw event information to produce a structured output of event information from the plurality of information sources in a common event-information format; by the automated system, receiving information about an organization from a plurality of different business systems of the organization and creating a structured organization description that includes, information about resources of the organization in a common organization-information format; by the automated system, applying threat assessment criteria to the structured output of the event information and to the structured organization description to produce an event-resource assessment of whether an event is likely to impact a resource of the organization; and by the automated system, determining a response recommendation for each event-resource assessment based on response criteria, and outputting the response recommendation to be displayed via a graphical user interface.

In Example 9, the subject matter of Example 8 includes, wherein the raw event information is stored in formats provided by the respective information sources.

In Example 10, the subject matter of Examples 8-9 includes, computing a criticality score that represents a degree of impact that an event is likely to have upon a resource of the organization.

In Example 11, the subject matter of Example 10 includes, de-prioritizing processing of event-resource assessments that have relatively lower criticality scores in favor of processing other event-resource assessments that have relatively higher criticality scores.

In Example 12, the subject matter of Examples 10-11 includes, wherein the criticality score is a single value that is computed from a plurality of categorized impact scores.

In Example 13, the subject matter of Examples 10-12 includes, computing a risk index for a resource of the organization based on historical data about that resource, the risk index representing a measure of susceptibility that resource has to events.

In Example 14, the subject matter of Examples 8-13 includes, generating notifications to specific personnel of the organization that are assigned responsibility for responding to event-resource incidents.

Example 15 is at least one non-transitory machine-readable storage medium containing instructions that, when executed on a computing system, causes the computing system to: receive incoming event information from a plurality of near-real-time information sources and storing raw event information; execute a data-mining algorithm on the raw event information to produce a structured output of event information from the plurality of information sources in a common event-information format; receive information about an organization from a plurality of different business systems of the organization and create a structured organization description that includes, information about resources of the organization in a common organization-information format; apply threat assessment criteria to the structured output of the event information and to the structured organization description to produce an event-resource assessment of whether an event is likely to impact a resource of the organization; and determine a response recommendation for each event-resource assessment based on response criteria, and output the response recommendation to be displayed via a graphical user interface.

In Example 16, the subject matter of Example 15 includes, wherein the raw event information is stored in formats provided by the respective information sources.

In Example 17, the subject matter of Examples 15-16 includes, instructions that, when executed, cause the computing system to compute a criticality score that represents a degree of impact that an event is likely to have upon a resource of the organization.

In Example 18, the subject matter of Example 17 includes, instructions that, when executed, cause the computing system to de-prioritize processing of event-resource assessments that have relatively lower criticality scores in favor of processing other event-resource assessments that have relatively higher criticality scores.

In Example 19, the subject matter of Examples 17-18 includes, wherein the criticality score is a single value that is computed from a plurality of categorized impact scores.

In Example 20, the subject matter of Examples 17-19 includes, instructions that, when executed, cause the computing system to compute a risk index for a resource of the organization based on historical data about that resource, the risk index representing a measure of susceptibility that resource has to events.

In Example 21, the subject matter of Examples 8-20 includes, instructions that, when executed, cause the computing system to generate notifications to specific personnel of the organization that are assigned responsibility for responding to event-resource incidents.

The embodiments above are intended to be illustrative and not limiting. In addition, although aspects of the present disclosure have been described with reference to particular embodiments, those skilled in the art will recognize that changes may be made in form and detail without departing from the scope of the inventive concepts as described herein.

Persons of ordinary skill in the relevant arts will recognize that the invention may comprise fewer features than illustrated in any individual embodiment described above. The embodiments described herein are not meant to be an exhaustive presentation of the ways in which the various features of the inventive concepts may be combined. Accordingly, the embodiments are not mutually exclusive combinations of features; rather, the inventive concepts may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

What is claimed is:

1. A system for facilitating organizational resilience, comprising:
an event monitor engine having an input to receive incoming event information from a plurality of near-real-time information sources, the event monitor engine operative to store raw event information;
an event data mining engine communicatively coupled to the event monitor engine, the event data mining engine operative to execute a data-mining algorithm on the raw event information to produce a structured output of event information from the plurality of information sources in a common event-information format;
an organization information structuring engine having an input to receive information about an organization from a plurality of different business systems of the organization, the organization information structuring engine operative to create a structured organization description that includes information about resources of the organization in a common organization-information format;
a threat assessment engine communicatively coupled to the event data mining engine and to the organization information structuring engine, the threat assessment engine operative to apply threat assessment criteria to the structured output of the event information and to the structured organization description to produce an event-resource assessment of whether an event is likely to impact a resource of the organization;
and
a response advisor engine communicatively coupled to the threat assessment engine, the response advisor engine operative to determine a response recommendation for each event-resource assessment based on response criteria, and to output the response recommendation to be displayed via a graphical user interface.

2. The system of claim 1, wherein the event monitor engine is operative to store the raw event information in formats provided by the respective information sources.

3. The system of claim 1, wherein the threat assessment engine is operative to compute a criticality score that represents a degree of impact that an event is likely to have upon a resource of the organization.

4. The system of claim 3, wherein the response advisor engine is operative to de-prioritize processing of event-resource assessments that have relatively lower criticality scores in favor of processing other event-resource assessments that have relatively higher criticality scores.

5. The system of claim 3, wherein the criticality score is a single value that is computed from a plurality of categorized impact scores.

6. The system of claim 3, wherein the threat assessment engine is operative to compute a risk index for a resource of the organization based on historical data about that resource, the risk index representing a measure of susceptibility that resource has to events.

7. The system of claim 1, further comprising:
a notifier engine communicatively coupled to the response advisor engine and to the organization information structuring engine, the notifier engine operative to generate notifications to specific personnel of the organization that are assigned responsibility for responding to event-resource incidents.

8. An automated method for facilitating organizational resilience, comprising:
by an automated system, receive incoming event information from a plurality of near-real-time information sources and storing raw event information;
by the automated system, executing a data-mining algorithm on the raw event information to produce a structured output of event information from the plurality of information sources in a common event-information format;
by the automated system, receiving information about an organization from a plurality of different business systems of the organization and creating a structured organization description that includes information about resources of the organization in a common organization-information format;
by the automated system, applying threat assessment criteria to the structured output of the event information and to the structured organization description to produce an event-resource assessment of whether an event is likely to impact a resource of the organization; and
by the automated system, determining a response recommendation for each event-resource assessment based on response criteria, and outputting the response recommendation to be displayed via a graphical user interface.

9. The method of claim 8, wherein the raw event information is stored in formats provided by the respective information sources.

10. The method of claim 8, further comprising:
computing a criticality score that represents a degree of impact that an event is likely to have upon a resource of the organization.

11. The method of claim 10, further comprising:
de-prioritizing processing of event-resource assessments that have relatively lower criticality scores in favor of processing other event-resource assessments that have relatively higher criticality scores.

12. The method of claim 10, wherein the criticality score is a single value that is computed from a plurality of categorized impact scores.

13. The method of claim 10, further comprising:
computing a risk index for a resource of the organization based on historical data about that resource, the risk index representing a measure of susceptibility that resource has to events.

14. The method of claim 8, further comprising:
generating notifications to specific personnel of the organization that are assigned responsibility for responding to event-resource incidents.

15. At least one non-transitory machine-readable storage medium containing instructions that, when executed on a computing system, causes the computing system to:
receive incoming event information from a plurality of near-real-time information sources and storing raw event information;
execute a data-mining algorithm on the raw event information to produce a structured output of event information from the plurality of information sources in a common event-information format;
receive information about an organization from a plurality of different business systems of the organization and create a structured organization description that includes information about resources of the organization in a common organization-information format;
apply threat assessment criteria to the structured output of the event information and to the structured organization description to produce an event-resource assessment of whether an event is likely to impact a resource of the organization; and
determine a response recommendation for each event-resource assessment based on response criteria, and output the response recommendation to be displayed via a graphical user interface.

16. The at least one machine-readable storage medium of claim 15, wherein the raw event information is stored in formats provided by the respective information sources.

17. The at least one machine-readable storage medium of claim 15, further comprising:
instructions that, when executed, cause the computing system to compute a criticality score that represents a degree of impact that an event is likely to have upon a resource of the organization.

18. The at least one machine-readable storage medium of claim 17, further comprising:
instructions that, when executed, cause the computing system to de-prioritize processing of event-resource assessments that have relatively lower criticality scores in favor of processing other event-resource assessments that have relatively higher criticality scores.

19. The at least one machine-readable storage medium of claim 17, wherein the criticality score is a single value that is computed from a plurality of categorized impact scores.

20. The at least one machine-readable storage medium of claim 17, further comprising:
instructions that, when executed, cause the computing system to compute a risk index for a resource of the organization based on historical data about that resource, the risk index representing a measure of susceptibility that resource has to events.

21. The at least one machine-readable storage medium of claim 8, further comprising:
instructions that, when executed, cause the computing system to generate notifications to specific personnel of the organization that are assigned responsibility for responding to event-resource incidents.
